(19) United States
(12) Patent Application Publication
(10) Pub. No.: US 2019/0294522 A1
(43) Pub. Date: Sep. 26, 2019

(54) DEVICES AND METHODS OF MONITORING NETWORK-CONNECTED CLIENT DEVICES

(71) Applicant: TELUS Communications Inc., Vancouver (CA)

(72) Inventor: Ravi PRASHER, Vaughan (CA)

(21) Appl. No.: 15/934,231

(22) Filed: Mar. 23, 2018

(51) Int. Cl. G06F 11/34; H04L 12/26

(52) U.S. Cl. CPC G06F 11/3438; H04L 43/065; G06F 11/3476; G06F 11/3452

(57) ABSTRACT

Devices and methods of monitoring network-connected client devices are provided. A device includes a processor, a communication subsystem coupled to the processor for transmitting a common electronic document, and a memory coupled to the processor. The device may be configured to receive a plurality of delivery reports from the client devices that received the common electronic document, the plurality of delivery reports including a first delivery report having first consumption data associated with the common electronic document at a first client device; generate an engagement vector from the plurality of delivery reports, the generated engagement vector includes a threshold metric for determining an extent of interaction with the common electronic document at respective client devices; and provide a compliance result for the first client device by comparing the engagement vector to the first consumption data of the first client device.

### FIELD

The present application generally relates to network-connected client devices and, in particular, to monitoring network-connected client devices.

### BACKGROUND

Electronic devices have become commonplace and the speed of electronically transmitting documents via network communications has increased. Documents traditionally delivered in hardcopy form are now commonly transmitted in electronic format to electronic devices associated with intended recipients. In some instances, the same document may be send to multiple electronic devices and existing techniques provide little ability for monitoring and managing such documents across a large number of electronic devices.

### BRIEF DESCRIPTION OF THE DRAWINGS

Reference will now be made, by way of example, to the accompanying drawings which show example embodiments of the present application, and in which:

FIG. 1 illustrates a block diagram of a system for monitoring a plurality of client devices, in accordance with an example of the present application;

FIG. 2 illustrates a simplified block diagram of an electronic device, in accordance with an example of the present application;

FIG. 3 illustrates a plan view of an electronic document, in accordance with an example of the present application;

FIG. 4 illustrates a method of monitoring a plurality of network-connected client devices, in accordance with an example of the present application;

FIG. 5 illustrates a method of determining a compliance result for a client device that received the common electronic document, in accordance with an example of the present application; and

FIG. 6 illustrates a method of monitoring a plurality of network-connected client devices, in accordance with an example of the present application.

Similar reference numerals may have been used in different figures to denote similar components.

### DESCRIPTION OF EXAMPLE EMBODIMENTS

In a first aspect, the present application describes a processor-implemented method of monitoring, by a sender device, a plurality of network-connected client devices, the client devices receiving a common electronic document from the sender device, respective client devices displaying the common electronic document on an output device for facilitating user interaction with the common electronic document. The method includes: receiving, via a network connection to the network-connected client devices, a plurality of delivery reports from the client devices that received the common electronic document, the plurality of delivery reports including a first delivery report having first consumption data associated with the common electronic document at a first client device; generating, by the sender device, an engagement vector from the plurality of delivery reports, the generated engagement vector including a threshold metric for determining an extent of interaction with the common electronic document at the respective client devices; and providing, for display by the sender device, a compliance result for the first client device by comparing the threshold metric to the first consumption data of the first client device.

In another aspect, the present application describes an electronic device monitoring a plurality of network-connected client devices. The electronic device includes a processor; a communication subsystem coupled to the processor for transmitting a common electronic document to the plurality of network-connected client devices, respective client devices displaying the common electronic document on an output device for facilitating recipient user interaction with the common electronic document on that client device; and a memory coupled to the processor and storing processor-readable instructions. The processor-readable instructions, when executed, cause the processor to: receive, via the communication subsystem, a plurality of delivery reports from the client devices that received the common electronic document, the plurality of delivery reports including a first delivery reporting having first consumption data associated with the common electronic document at a first client device; generate an engagement vector from the plurality of delivery reports, the generated engagement vector includes a threshold metric for determining an extent of interaction with the common electronic document at the respective client devices; and provide, for display at the electronic device, a compliance result for the first client device by comparing the threshold metric to the first consumption data of the first client device.

In yet a further aspect, the present application describes non-transitory computer-readable storage medium storing processor-readable instructions which, when executed, configure a processor to perform one or more of the methods described herein. In this respect, the term processor is intended to include all types of processing circuits or chips capable of executing program instructions.

Other aspects and features of the present application will be understood by those of ordinary skill in the art from a review of the following description of examples in conjunction with the accompanying figures.

Electronic devices have become commonplace. The speed of electronically transmitting documents via network communications has increased. Documents traditionally delivered in hardcopy form are now commonly transmitted in electronic format to electronic devices associated with intended recipients. Documents may include contracts/agreements, sales/promotional materials, or communications where acknowledgement that the documents have been read may be desirable. For example, a company may wish to send employees a memorandum outlining updated electronic mail (“e-mail”) privacy policies and may wish to receive acknowledgement that said memorandum was read and understood by respective employees. In other examples, a sales team for an emerging technology company may wish to transmit electronic documents to potential investors or clients for marketing new products. The sales team may wish to understand whether said potential investors or said clients have reviewed the documentation, or to what extent such documentation has been reviewed, such that any future discussions or communication may be based on knowledge of whether the documentation had been previously reviewed. In another example, “clickwrap agreements” can be lengthy agreements included with computer software installation packages and can be used by software companies to disclaim implied warranties, choose governing law and forum for resolving disputes, etc. Software companies may wish to ensure that these agreements are reviewed by software end users.

Some document server systems, such as e-mail server system, may transmit a “read receipt” request along with electronic communications. The e-mail server system may request that a document recipient confirm receipt of the message via a short return message. However, read receipt requests can be ignored and read receipt requests may not provide confirmation that the electronic message was actually read or consumed by the document recipient.

Some document server systems may transmit hyperlinks within electronic messages such that the document server system is notified when a recipient user accesses a document via the hyperlink. However, such hyperlinks provide limited information on whether the electronic document provided by the hyperlink was read. In fact, a recipient user may accidentally click hyperlinks and skew the indication that the electronic document provided by the hyperlink was actually read.

Some other document server systems may insert document scroll triggers within Internet webpages for determining whether a recipient user may have read a document. When a user scrolls to the end of a lengthy electronic document, the document server system may be notified that the document has been scrolled through. However, such methods for determining that a document has at least been viewed provides minimal assurance that the recipient user has actually read the electronic document. In some examples, the recipient user may simply scroll to the end of the lengthy electronic document in the span of a few seconds and proceed with other tasks.

It may be desirable to provide systems and methods for confirming an extent that a document recipient has interacted with an electronic document that is received at an electronic device associated with that recipient user. Such improved systems and methods for monitoring electronic devices have now been devised.

Many examples described herein relate to accessing electronic devices. For example, electronic devices may include an endpoint including one or more of any of the following: mobile devices (e.g., smartphones, tablets, phablets, laptops, wearables, gaming devices, navigation devices, cameras, etc.), computers (e.g., laptops, desktops, all-in-one computers, etc.), IoT (Internet of Things) devices (e.g., vehicles, appliances, smart devices, connected devices, buildings including homes, etc.), EoT (Enterprise of Things) devices (i.e., IoT devices in an enterprise) and any other nodes or combination thereof.

In addition, examples described herein may relate to electronic devices displaying electronic documents or content on an input and/or output device for facilitating user interaction with the electronic documents. For example, an Internet web-page may be displayed on a touchscreen electronic device and a user of the electronic device may interact with the Internet web-page by way of the touchscreen display. Other examples for providing interaction or input include pointer device input, keyboard input, voice input, or any other device for receiving input from the user of the electronic device.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

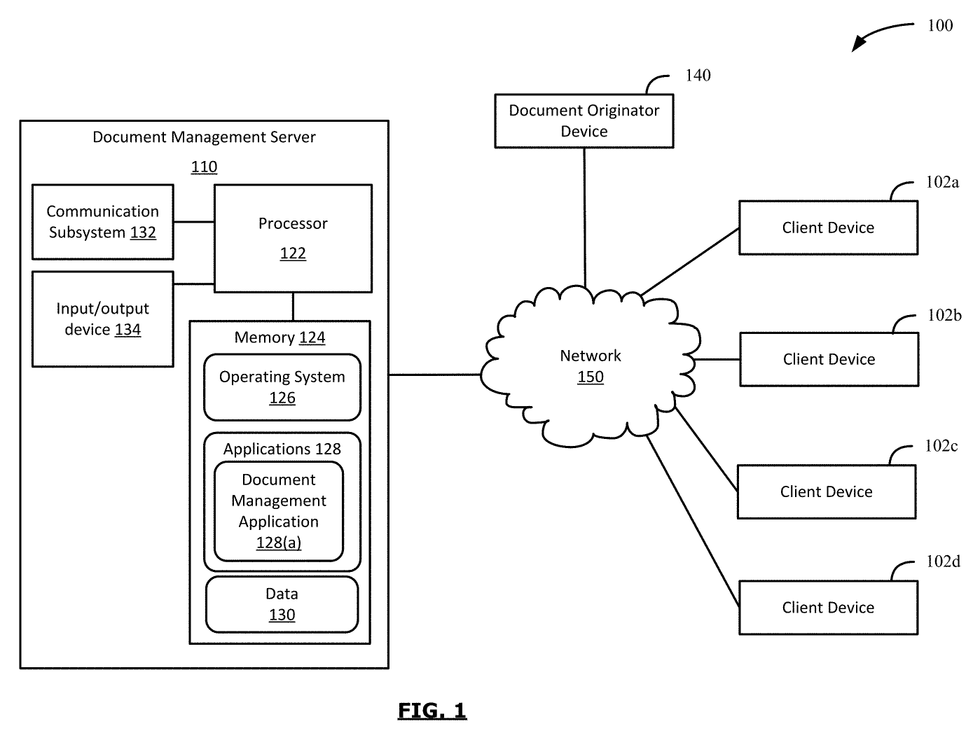

Reference is now made to FIG. 1, which illustrates a block diagram of a system 100 for monitoring a plurality of client devices, in accordance with an example of the present application. The system may include one or more client devices, a document management server 110, and a document originator device 140. The one or more client devices, the document management server 110, and the document originator device 140 may communicate over a network 150, which may include public networks (e.g., the Internet), private networks, cellular networks, and any combinations thereof which may be wired networks, wireless networks, or a combination of wired and wireless networks. In some examples, any combination of the one or more client devices, the document management server 110, and the document originator device 140 may communicate via peer-to-peer communication, such as short-range communication protocols. Short-range communication protocol examples may include Bluetooth™, radio-frequency identification (RFID), infrared, or near-field communication (NFC).

The document management server 110 may include at least one processor 122. The processor 122 may be coupled to a memory 124 and a communication subsystem 132. The processor 122 may also be coupled to other subsystems, such as an input/output device 134 or other subsystems not illustrated in FIG. 1.

The communication subsystem 132 may include subsystems for wired or wireless data communication. For example, the communication subsystem 132 may transmit or receive electronic messages or data to or from other devices via the network 150. In other examples, the communication subsystem 132 may transmit or receive electronic messages directly to or from other devices in the system 100 via various other communication protocols, such as short-range communication protocols.

The memory 124 may include volatile and non-volatile memory. At least part of the memory 124 may store processor-readable instructions. The processor-readable instructions stored in memory 124 may include an operating system 126. The operating system 126 may provide basic device functions and may provide a run-time environment within which other processor-readable instructions may be executed. The processor-readable instructions may also include applications 128 which when executed by the processor 122 may carry out some of the operations described herein. Example applications 128 may include a word processing application, a data application, a mapping or location tracking application, or other such applications executing operations described herein.

In some examples, the applications 128 may include a document management application 128a which may include instructions for monitoring a plurality of network-connected client devices, where the client devices may receive a common electronic document from the document management server 110. As will be described, each client device may display the common electronic document on an output device for facilitating user interaction with the common electronic document. For example, the document management application 128a may include processor-readable instructions that, when executed, cause the processor 122 to: receive, via a network connection to the network-connected client devices, a plurality of delivery reports from the client devices that received the common electronic document; generate an engagement vector from the plurality of delivery reports, where the generated engagement vector includes a threshold metric for determining an extent of interaction with the common electronic document at each respective client device; and provide a compliance result for a first client device by comparing the engagement vector to first consumption data of the first client device.

The memory 124 may also include data 130. The data 130 may include electronic documents that may be transmitted by the document management server 110 to one or more of the client devices. For example, electronic documents may include email communication messages, Internet webpages for displaying workplace policies, contracts or agreements, charts or photographs, or other content that a recipient user of a client device may read or interact with.

The data 130 may also include delivery reports received from client devices that received a particular common electronic document. Delivery reports may include, for example, information on how quickly a user that was interacting with the common electronic document had scrolled through the document. Delivery reports may include information on whether that user provided textual input or whether that user utilized a pointing device input while interacting with the common electronic document. In some examples, the common electronic document may be subdivided into two or more document sections and the delivery report may include information on a duration of time that the client device user actively displayed the respective document sections on a displayable portion of the screen. In some examples, the data 130 may include user category records or electronic device user profiles, such that particular delivery reports may be associated with individual user profiles for statistical or trend analysis.

The document management server 110 may include input/output devices 134, and a document administrator or a user may interact with the document management server 110. For example, the document management server 110 may include an output interface, such as a display screen, and at least one input interface. The input interface may be coupled to a touch sensitive overlay on a visual display for detecting touch-based input. Other examples of input interface devices may include keyboards, keypads, touchpads, mice, keyboard with touch-sensitive surface, or various buttons. In some examples, the at least one input interface may include a communication port for receiving input via an external peripheral device.

As described, the system 100 may include one or more client devices. A first client device 102a, a second client device 102b, a third client device 102c, and a fourth client device 102d are illustrated in FIG. 1; however, any number of client devices may be included in the system 100.

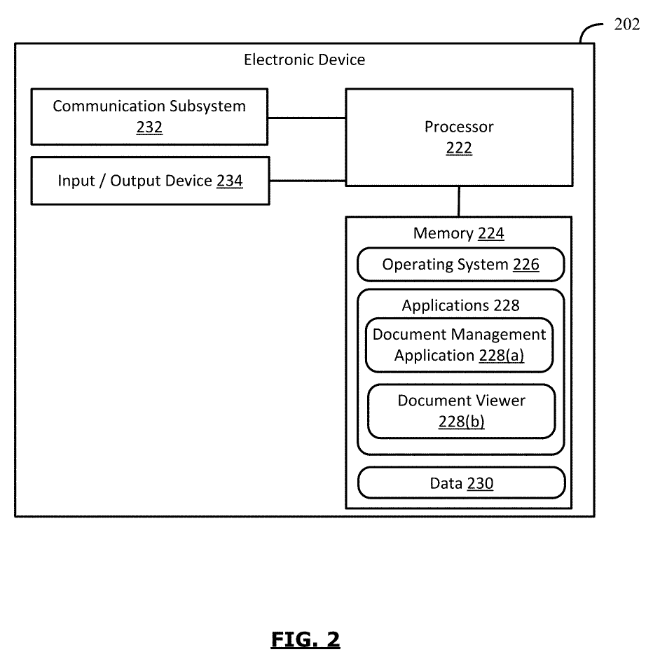

Reference is now made to FIG. 2, which is a simplified block diagram of an electronic device 202, in accordance with an example of the present application. The electronic device 202 may be an example of one or more of the client devices in the system 100 of FIG. 1. For example, the electronic device 202 may be an endpoint device including any of smartphones, tablets, phablets, laptops, wearables, gaming devices, navigation devices, camera or image capture devices, laptops, desktops, all-in-one computers, vehicles, appliances, smart devices, or any other nodes or combination thereof. In particular, the electronic device 202 may be any endpoint device that may receive an electronic document, via a network connection, and that may display the electronic document on an output device for facilitating user interaction with the received electronic device. In some examples, the electronic device 202 may be an example document originator device 140 (FIG. 1), where the originator user transmits a common electronic document to the document management server 110 (FIG. 1) such that the common electronic document may be distributed to the plurality of network-connected client devices.

The electronic device 202 may include at least one processor 222. The processor 222 may be coupled to a memory 224, a communication subsystem 232, and one or more input/output device 234. The processor 222 may be coupled to other subsystems that are not illustrated in FIG. 2.

The communication subsystem 232 may include subsystems for wired or wireless data communication with other devices of the system 100 of FIG. 1. For example, the communication subsystem 232 may transmit or receive electronic messages or data to or from other client devices, the document management server 110 (FIG. 1), or the document originator device 140. The communication subsystem 232 may transmit or receive electronic messages or data via the network 150 or directly via peer-to-peer communication protocols.

The one or more input/output device 234 may include output devices such as display screens or speaker devices. For example, display screens may be configured for displaying a common electronic document received from the document management server 110 or from another client device of the system 100 (FIG. 1). Further, the input/output device may include an input device for facilitating user interaction with the common electronic document. For example, the input device may be a touch sensitive overlay for detecting touch-based input from the user. In some examples, the input device may include a keyboard, keypad, touchpad, mouse, or other interface buttons or elements. The input device may also be for receiving input from the respective user, such as for creating electronic documents, etc.

In some examples, a common electronic document may be an electronic audio document for visually impaired users, where the electronic audio document may be configured to include durations of time for receiving interactive input from the visually impaired user. The output device may be an audio output device, such as a speaker or other transducer. In this example, the input device may be a microphone for detecting voice input, where the voice input may be a user's response to the electronic audio document.

The memory 224 may include volatile and non-volatile memory. At least part of the memory 224 may store processor-readable instructions. The processor-readable instructions may include an operating system 226. The operating system 226 may provide basic electronic device functions and may create a run-time environment within which other processor-readable instructions may be executed. The processor-readable instructions may also include applications 228 which when executed by the processor 222 may carry out some of the operations described herein. Example applications 228 may include a word processing application, a data application, a mapping or location tracking application, or other such applications executing operations described herein.

In some examples, the applications 228 may include a document management application 228(a) which may include instructions for monitoring the plurality of other network-connected client devices described herein, where the other client devices may receive a common electronic document from said electronic device 202. The document management server 110 (FIG. 1) or any of the client devices in FIG. 1 may be a sender device for transmitting a common electronic document to the one or more other client devices. If a client device in FIG. 1 is configured as a sender device for transmitting the common electronic document to the one or more other client devices, the sender device may transmit the common electronic document via the network 150 or via peer-to-peer communication paths.

The applications 128 may include a document viewer application 228(b) which may include instructions for displaying a received common electronic document or for collecting interaction input from a user interacting with the common electronic document. For example, the document viewer application 228(b) may include instructions for decrypting received common electronic documents that may be password protected and may include instructions for encrypting a delivery report having consumption data associated with the user interaction with the common electronic document.

The memory 224 may also include data 230. The data 230 may include common electronic documents received from the document management server 110 or common electronic documents received from other client devices in the system 100 (FIG. 1).

The data 230 may also include consumption data associated with respective common electronic documents at the electronic device 202. That is, the data 230 may include a plurality of sets of consumption data, where each set of consumption data may correspond to user interaction with a respective common electronic document on the electronic device 202. The data 230 may include other data records including, for example, user profiles for multiple users of the electronic device 202. That is, multiple users may utilize the electronic device 202, and when a respective user utilizes the electronic device 202, that respective user may enter login credentials such that user consumption data for that respective user is monitored.

The electronic device 202 may include other components apart from those identified in FIG. 2 including, for example, a power source or a power interface for connecting to a power source.

A document originator or document author may find it desirable to understand an extent to which a document recipient may have interacted with an electronic document. For example, it may be desirable to determine whether the document recipient may have spent requisite amount of time for understanding the contents of the electronic document. If the document recipient scrolls through an electronic document from beginning to end in less than 2 seconds, an inference may be made that the document recipient may not have sufficiently interacted with the electronic document for understanding the crux or salient information laid out therein.

Other document interaction indicators, such as pointer-over information, hyperlink click-through data, textual input indicators, or audio feedback indicators (e.g., voice command input) may also be used for determining the extent that the document recipient has interacted with the common electronic document. For example, if voice commands, where such commands are anticipated for receipt, are not received (e.g., user could have walked away from the electronic device 202 while the common electronic document is provided), an inference may be made that the document recipient may not have sufficiently heard the common electronic document in audio format. In another example, if textual input is anticipated throughout the common electronic document and such textual input is not received, an inference may be made that the document recipient may not have sufficiently interacted with the common electronic document.

To assess the extent that the document recipient had interacted with an electronic document, a threshold metric may be used by a document management server. For example, to determine whether the document recipient could have read an electronic document having several paragraphs of dense text, the document management server may determine whether the rate at which the document recipient scrolled through the electronic document via an input device is less than a scroll rate threshold. In other examples, other threshold metrics or combinations of threshold metrics may be used. It can be appreciated that in some examples, threshold metrics can be predetermined thresholds for determining whether: (a) a document recipient sufficiently engaged with an electronic document; or (b) the document recipient simply glossed over the electronic document. The predetermined thresholds used by the document management server 110 can be static and may not represent evolving skill level of document recipients or evolving electronic document characteristics over time. Further, predetermined thresholds may not take into account recipient user characteristics, such as reading comprehension skill, familiarity with subject matter, or other factors that may be common among recipient users of a commonly distributed electronic document. It may be desirable to provide for systems and methods for adapting to evolving inputs to the document management server 110 while monitoring the extent of user interaction with electronic documents across a plurality of network-connected client devices.

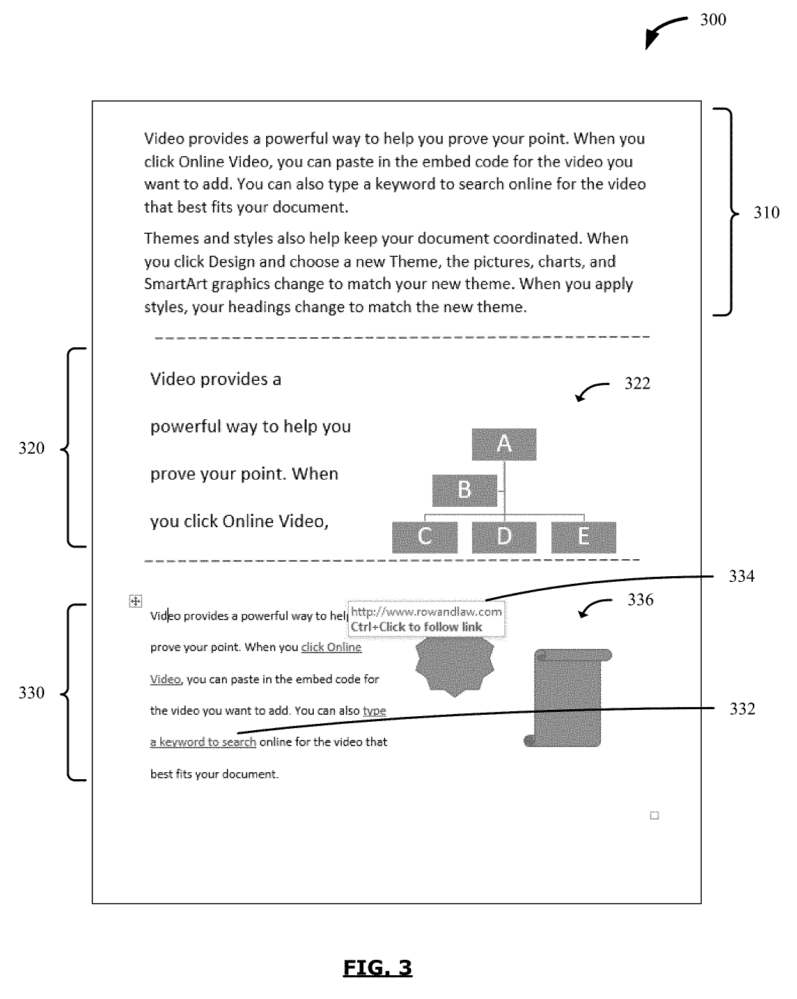

Reference is now made to FIG. 3, which is a plan view of a common electronic document 300, in accordance with an example of the present application. In some examples, the common electronic document 300 may be transmitted by a document originator device 140 (FIG. 1) to a document management server 110 (FIG. 1), and the document management server 110 may transmit the common electronic document 300 to one or more of the client devices in the system 100 (FIG. 1).

In some other examples, the document originator device 140 may be one of the client devices in the system 100 and the document originator device 140 may transmit the common electronic document 300 to each of the other client devices in the system 100. The document originator device 140 may transmit the common electronic document to each of a first client device 102a, a second client device 102b, a third client device 102c, and a fourth client device 102d via the network 150 or via a peer-to-peer communication channel Although four client devices are illustrated in FIG. 1, any number of client devices may be included in the system 100.

The common electronic document 300 may be a document that the document originator device 140 may wish to distribute to one or more client devices within an organization. For example, the common electronic document 300 may be an updated workplace policy for employees within a corporation. Alternatively, the common electronic document 300 may include sales/marketing materials that the document originator device 140 may desire to widely distribute to a network of potential new customers.

The common electronic document 300 may include one or a combination of content features. For example, the common electronic document 300 may include a first section 310 having dense textual material. The common electronic document 300 may include a second section 320 having sparse textual matter, such as a bulleted list of information or large sized font. Further, the second section 320 may include a meaningful diagram 322 graphically conveying information. The meaningful diagram 322 may be a tree-diagram or other illustration for efficiently conveying information, as compared to paragraphs of text describing information. It can be appreciated that the meaningful diagram 322 may convey information, but may also require that a recipient user spend a requisite amount of time for understanding the information conveyed by the meaningful diagram 322.

In some examples, the common electronic document 300 may include a third section 330 including textual matter having hyperlinks or supplemental textual matter activated by pointer-activated actions (e.g., “mouse-over” actions). For example, the textual matter in the third section 330 may include hyperlinks 332 in-line with the textual matter, and may include “hover-activated” textual matter associated with supplemental textual matter 334 that is revealed when a pointing cursor (e.g., mouse arrow) may “hover over” the particular textual matter. Further, the third section 330 may include non-meaningful images 336 that may be included for aesthetic presentation.

The described sections of the common electronic document 300 are illustrative of an example common electronic document, and the common electronic document 300 may include other combinations of subject matter components or characteristics apart from those illustrated in FIG. 3.

It can be appreciated that the extent a document recipient interacts with the sections of the common electronic document 300 may vary depending on the characteristics of each respective section. Thus, in some examples, the common electronic document 300 may be divided into one or more document section, where each of the one or more document section can be associated with a threshold metric for determining an extent of interaction with that respective document section. That is, granular threshold metrics may be used for respective sections based on characteristics of the respective sections.

Referring to FIG. 3, the document recipient may require more time for interacting and reading the textual matter in the first section 310 than the textual matter in the second section 320. In some examples, the document recipient may require more time for deciphering the meaningful diagrams 322 graphically conveying dense information than the non-meaningful images 336 in the third section 330. In some examples, the extent that the document recipient interacts with the common electronic document 300 may be determined based on the rate at which the document recipient scrolls through the common electronic document 300 and the density of the matter in the common electronic document 300. Dense matter, such as dense text in the first section 310 or the meaningful diagram 322, cannot be consumed or read by the document recipient scrolling at a relatively high scroll rate, whereas sparse matter may be consumed or read by the document recipient scrolling at that relatively high scroll rate.

In some examples, the extent that the document recipient interacts with the common electronic document may be associated with particular input by the document recipient. For example, if the common electronic document 300 includes “hover-activated” textual matter with supplemental textual matter 334, the extent that the document recipient interacts with the common electronic document 300 may be determined based on the extent or based on a tally of the number of supplemental textual matter 334 that may be revealed during the document recipient's pendency with the common electronic document 300. That is, the extent that the document recipient interacts with the common electronic document 300 may be determined based on pointer cursor activity.

In some examples if the common electronic document 300 includes several hyperlinks for retrieving secondary electronic documents that may be necessary for understanding the contents of the common electronic document 300, the extent that the document recipient interacts with the common electronic document 300 may be determined based on a tally of the number of hyperlinks 332 appearing in-line with textual matter and that have been activated. In some examples, hyperlinks 332 may be placed in categories of importance and the extent that the document recipient interacts with the common electronic document 300 may depend on the number of “high” importance hyperlinks that the document recipient interacts with.

Because determining the extent that the document recipient interacts with the common electronic document 300 can depend on threshold metrics and because each document recipient associated with a client device may read or interact with the common electronic document at varying speeds, it may be desirable to provide systems and methods for determining the extent that any given document recipient interacts with the common electronic document 300 against an engagement vector or one or more threshold metrics derived from consumption data from each of the client devices that received the common electronic document. That is, in some examples, it may be useful to determine whether a recipient user of a common electronic document has been read or consumed based on thresholds that may be derived from crowdsourced data.

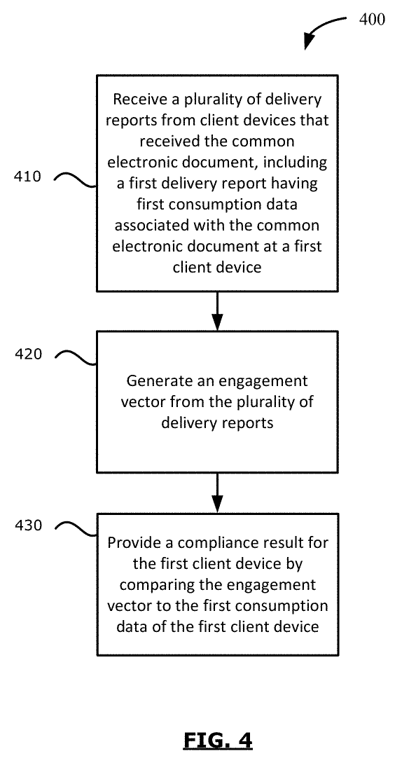

Reference is now made to FIG. 4, which illustrates a method 400 of monitoring a plurality of network-connected client devices, in accordance with an example of the present application. The method 400 may include operations that may be carried out by the document management server 110 (FIG. 1); however, it is contemplated that client devices or a document originator device 140 (FIG. 1) may also perform some or all of the operations of the method 400. The method 400 may be implemented, at least in part, through processor-executable instructions stored for example at the document management application 128(a) (FIG. 1). In some examples, one or more of the operations may be implemented via processor-executable instructions of other applications 128 (FIG. 1) or of the operating system 126 (FIG. 1). In the description that follows, the example method 400 may be described with reference to the example common electronic document 300 illustrated in FIG. 3.

In some examples, the sender device may be the document management server 110. The document management server 110 may receive, from the document originator device 140 or any of the client devices, the common electronic document 300 for distribution to the plurality of network-connected client devices. The plurality of network-connected client devices may include any of the first client device 102a, the second client device 102b, the third client device 102c, or the fourth client device 102d. That is, the document management server 110 may act as a hub for managing and distributing electronic documents and for monitoring one or more client devices which may receive electronic documents distributed by the document management server 110.

The one or more client devices may receive the common electronic document 300 from the document management server 110 via the network 150 or via any peer-to-peer communication protocol. Each client device receiving the common electronic document 300 may display that common electronic document 300 on an output device for facilitating user interaction with the common electronic document 300. The common electronic document 300 received at each of the one or more client devices may be a copy of the common electronic document 300 for conveying the same information to recipient users of the one or more client devices.

For example, if the common electronic document 300 is an Internet webpage, each client device may display the Internet webpage on a web browser and may collect user input associated with user interaction with the common electronic document 300. In some examples, the display device may include a finite display surface or a finite display resolution. Thus, a portion or a subset of the common electronic document 300 may be displayed on the display device at a discrete point in time. For example, the first section 310 may be initially displayed to the recipient user, and when the recipient user scrolls using an input device, the second section 320 may be subsequently displayed to the recipient user. Similarly, when the recipient user further scrolls through the common electronic document 300 using the input device, the third section 330 may subsequently be displayed to the recipient user. In some other examples, if the common electronic document 300 is an electronic audio document, each client device may produce audio output and receive audio input from a user of the client device.

Each of the client devices may detect and collect, via the input device, input from the recipient user corresponding to interaction with the common electronic device. In some examples, the processor 222 (FIG. 2) of the client device may store the received input as data 230 (FIG. 2) in a delivery report for that client device. Because the system 100 may include a one or more client devices, each of the client devices may generate a respective delivery report for the common electronic document 300 received at that client device.

At operation 410, the processor 122 may receive, via a network connection to the network-connected client devices, a plurality of delivery reports from the client devices that received the common electronic document 300. The plurality of delivery reports may include a first delivery report having first consumption data associated with the common electronic document at a first client device 102a. The respective delivery report may include data capturing the extent that a recipient user at a respective client device may have interacted with the common electronic document 300.

In some examples, the first consumption data may include a first scroll rate of the common electronic document displayed at the first client device 102a. For example, the first scroll rate may include data indicating the speed at which the recipient user may have scrolled from the first section 310 to the second section 320, and subsequently to the third section 330. In some examples, the first scroll rate may also include data indicating the speed at which the recipient user may have scrolled from the first line of text to the last line of text in the first section 310. In some examples, the first scroll rate may also include data indicating the speed at which the recipient user may have scrolled to and past the meaningful diagram 322. That is, the first scroll rate may capture the duration of time that the recipient user may have spent deciphering the meaningful diagram 322 of the common electronic document 300.

In some examples, the first consumption data may include a first click-through count of the common electronic document 300 displayed at the first client device 102a. For example, the first click-through count may include data indicating how many or which of the hyperlinks 332 (FIG. 3) that are in-line with textual matter have been engaged by the recipient user. In some examples, particular hyperlinks 332 in the common electronic document 300 may be identified by the processor 122 as “important” hyperlinks that, when clicked by the recipient user, may indicate that the recipient user has interacted with salient information of the common electronic document 300.

In some examples, the first consumption data may include a first hover-activation count of the common electronic document 300 displayed at the first client device 102a. For example, the first hover-activation count may include data indicating the duration that a pointer device (e.g., mouse cursor) may have engaged “hover-activated” textual matter or data indicating the number of “hover-activated” textual matter that the pointer device may have engaged in the common electronic document 300.

Other types of data may be included in the first consumption data. For example, when the common electronic document 300 includes fields for receiving text input from the recipient user (not illustrated in FIG. 3), the first consumption data may include a text input count when the recipient user interacts with the common electronic document 300.

That is, the recipient user inputting greater amount of text or inputting text at greater number of portions of the common electronic, the first consumption data may indicate the extent that the recipient user may have interacted with the common electronic document. The first consumption data may include other types of data apart from those illustrated in FIG. 3 or those described herein.

At operation 420, the processor 122 may generate an engagement vector from the plurality of delivery reports. The generated engagement vector may include one or more threshold metrics for determining an extent of interaction with the common electronic document 300 at each respective client device. For instance, the generated engagement vector may be a model for associating: (A) one or more quantitative measures, such as the extent that a respective employee has interacted, via an associated client device, with the common electronic document 300, with (B) qualitative measures, such as the extent that the respective employee associated with that associated client device has read and understood the contents of the common electronic document 300. That is, the quantitative measures may be a proxy for determining qualitative measures relating to the common electronic document 300.

In some examples, the generated engagement vector may be based on a model for graphically displaying: (a) sections of a page (e.g., first section 310, second section 320, third section, 330, etc) along an x-axis with (b) average time that recipient users may have spent viewing the respective sections (e.g., average time information received from respective delivery reports). The engagement vector may be an extrapolated curve or a curve representing trends, such that the engagement vector may represent or define threshold metrics based on crowdsourced data from each of the client devices that received the common electronic document 300.

In some examples, the engagement vector for the common electronic document 300 may be generated upon receipt of a requisite number of delivery reports. That is, the engagement vector for the common electronic document 300 may be generated after the document management server 110 receives numerous delivery reports from respective client devices. In some examples, the processor 122 may generate the engagement vector when the document management server 110 has received a delivery report from 80% of the client devices that received the common electronic document 300. The operations for determining whether the common electronic document 300 has been read by a recipient user at a corresponding client device may be based on one or more threshold metrics that are devised from aggregated or crowdsourced data from the client devices in the system 100. That is, the processor 122 may generate an engagement vector from statistical analysis of a plurality of received delivery reports. Thus, the document management server 110 may not need to set static or arbitrary threshold metrics for determining whether a recipient user of an associated client device has read and understood the common electronic document 300.

For example, the threshold metric may include a scroll rate threshold metric for determining the rate of user interaction of the common electronic document at the respective client devices. When generating the engagement vector, the processor 122 may determine an average scroll rate for the common electronic document 300 from delivery reports of the plurality of client device, such that the scroll rate threshold metric may be the determined average scroll rate.

In another example, the threshold metric may include a click-through threshold for determining an extent of interaction with hyperlinks. A hyperlink may be a reference or link to another document. That is, the recipient user of the associated client device may click or engage a hyperlink for accessing other data reference by that hyperlink. Thus, in some examples, when generating the engagement vector, the processor 122 may determine an average number of hyperlinks that may have been clicked on or engaged for the common electronic document 300, such that the click-through threshold may be the determined average number of engaged hyperlinks.

Based on the described examples, the processor 122 may dynamically generate the engagement vector based on input (e.g., delivery reports) received from two or more client devices, such that determining whether the recipient user of an associated client device may have read and understood the common electronic document 300 may be based on crowdsourced data from other recipient users. By generating the engagement vector based on input from multiple client devices, the processor 122 may not rely on static or arbitrarily determined threshold metrics for determining whether recipient users have read and understood the common electronic document 300. That is, the generated engagement vector may be derived from statistical analysis of the received delivery reports.

In some examples, in response to receiving, via the network 150, further delivery reports from further client devices receiving the common electronic document 300, the processor 122 may update the generated engagement vector based on the received further delivery reports. That is, in some examples, the document management server 110 may not immediately receive delivery reports from one or more client devices that received the common electronic document 300. Accordingly, the processor 122 may refine, over time, the generated engagement vector based on further delivery reports from further client devices that received the common electronic document 300.

Because the engagement vector associated with a common electronic document 300 may not be generated until a sufficient sample size of delivery reports have been received, in some examples, the processor 122 may not determine in real-time (or near real-time) whether a recipient user may have read or interacted with the common electronic document 300. In some examples, even when an engagement vector may be generated, the engagement vector may be updated as further delivery reports from other client devices are received.

At 430, the processor 122 may provide, for display by the document management server 110, a compliance result for the first client device by comparing the engagement vector, or one or more threshold metrics, to the first consumption data of the first client device 102a. In some examples, the compliance result may be based on a threshold metric, and the threshold metric may be a proxy for determining whether a recipient user of a client device has read and comprehended the common electronic document 300.

In some examples, the threshold metric may include a scroll rate threshold. Thus, prior to determining the compliance result for the first client device, the processor 122 may determine, based on the first consumption data, that a first scroll rate of the common electronic document 300 displayed at the first client device 102a is less than the scroll rate threshold. In response to determining that the first scroll rate of the common electronic document displayed at the first client device 102a is less than the scroll rate threshold, the processor 122 may determine that the common electronic document 300 has been read by the recipient user at the first client device 102a.

In some examples, the processor 122 may determine based on the first consumption data that the first scroll rate of the common electronic document 300 displayed at the first client device 102a is greater than the scroll rate threshold. Thus, in response to determining that the first scroll rate of the common electronic document displayed at the first client device 102a is greater than the scroll rate threshold, the processor 122 may determine that the common electronic document 300 may not have been read by the recipient user at the first client device 102a. That is, even though the common electronic document 300 may have been launched or displayed on an output device, the recipient user of the first client device 102a may have disregarded the contents and scrolled through the common electronic document 300 received at the first client device 102a.

In some examples, the threshold metric may include a click-through threshold for determining the extent of interaction with hyperlinks. Thus, prior to determining the compliance result for the first client device, the processor 122 may determine, based on the first consumption data, that a click-through rate of the common electronic document 300 displayed at the first client device 102a is greater than the click-through threshold. In response to determining that the click-through rate of the common electronic document 300 displayed at the first client device 102a is greater than the click-through threshold, the processor 122 may determine that the common electronic document 300 has been read by the recipient user at the first client device.

In some examples, the processor 122 may determine, based on the first consumption data, that the click-through rate of the common electronic document 300 displayed at the first client device 102a is not greater than the click-through threshold. In response to determining that the click-through rate of the common electronic document 300 displayed at the first client device 102a is not greater than the click-through threshold, the processor 122 may determine that the common electronic document 300 may not have been read by the recipient user at the first client device 102a. That is, even though the common electronic document 300 may have been launched or displayed on an output device, the recipient user of the first client device 102a may have skimmed the common electronic document 300 and may not have engaged with the content (e.g., hyperlinks or information referenced by hyperlinks) indicative of comprehending the common electronic document 300.

In some examples, the common electronic document 300 may be divided into more than one document section. Referring again to FIG. 3, the common electronic document 300 may be divided into a first section 310 having dense textual material, a second section 320 having sparse textual matter or a meaningful diagram 322, or a third section 330 including textual matter having hyperlinks or supplemental textual matter activated by pointer-activated actions. Each of the document sections may be associated with one or more threshold metric. Thus, prior to determining the compliance result for the first client device, the processor 122 may determine an extent of interaction with the respective document sections for an overall determination on whether the common electronic document has been read by the recipient user at the first client device. In some examples, the engagement vector may include two or more threshold metrics, and the processor 122 may determine a compliance result for the first client device 102a based on one or a combination of the threshold metrics associated with the common electronic document 300.

A greater the number of delivery reports received at the document management server 110 may translate into increasing confidence in determining how recipient users associated with respective client devices may be interacting with the distributed common electronic document 300. As more delivery reports are received and associated with a given common electronic document, the management server 110 may generate trend or statistical analysis information, and the trend or statistical analysis information may be a proxy for determining an extent that a typical recipient user may have interacted with the common electronic document. It may be desirable to associate a confidence value with a compliance result for identifying, for example, whether the common electronic document 300 has been read by a recipient user.

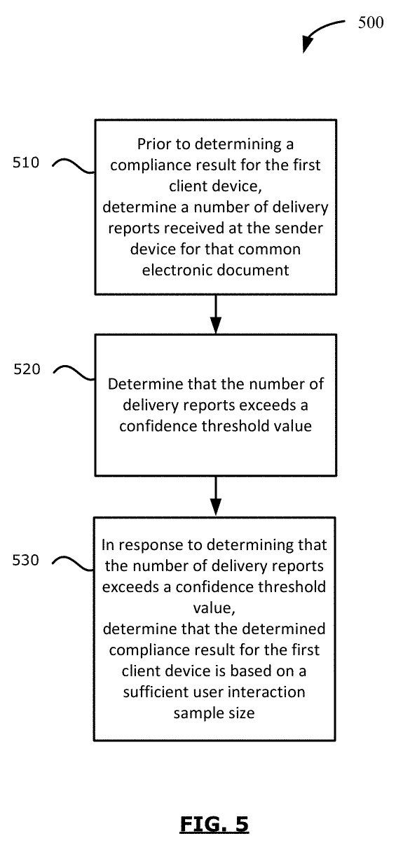

Reference is now made to FIG. 5, which illustrates a method 500 of determining a compliance result for a client device that received the common electronic document, in accordance with an example of the present application. The method 500 may include operations that may be carried out by the document management server 110 (FIG. 1); however, client devices or a document originator device 140 (FIG. 1) may also perform some or all of the operations of the method 500. The method 500 may be implemented, at least in part, through processor-executable instructions stored for example at the document management application 128(a) (FIG. 1). In some examples, one or more of the operations may be implemented via processor-executable instructions of other applications 128 (FIG. 1) or of the operating system 126 (FIG. 1).

Prior to providing the compliance result for the first client device (e.g., operation 430, FIG. 4), at operation 510, the processor 122 may determine a number of delivery reports received at the document management server 110 for the common electronic document 300. In some instances, the processor 122 may distribute, by transmitting via the communication subsystem 132 (FIG. 1), the common electronic document 300 to the plurality of client devices. However, the transmission of the common electronic document 300 may be delayed. In some cases, the delay may be attributed to network latency. In some cases, the delay may be attributed to a delay in receipt or consumption of the common electronic document 300 at the respective client devices. That is, a subset of client devices may not transmit a delivery report to the document management server 110 until the recipient user associated with that client device interacts with the common electronic document 300. Thus, the number of delivery reports received at the document management server 110 at a given time may be less than the number of instances of the common electronic document 300 that were transmitted to client devices.

At operation 520, the processor 122 may determine that the number of received delivery reports exceeds a confidence threshold value. The confidence threshold value may be expressed as a percentage of the number of instances of the common electronic document 300 that were transmitted to client devices. For example, if the confidence threshold value is 75% and if the common electronic document 300 was transmitted to one hundred client device each being associated with a recipient user, the processor 122 may not provide indication that a confidence value is based on a sufficient sample size until seventy-five delivery reports associated with the common electronic document 300 are received.

In some other instances, the confidence threshold value may be expressed as an absolute value. For example, the confidence threshold value may be one hundred delivery reports associated with the common electronic document 300. That is, the processor 122 may determine that one hundred delivery reports may be a minimum for a sufficient user interaction sample size.

In some other instances, the processor 122 may dynamically determine the confidence threshold value based on the variability or complexity of the common electronic document 300. For example, the processor 122 may dynamically determine that a discrete confidence threshold value (e.g., 100) may be sufficient for determining whether a simple electronic document has been read by a recipient user; whereas the processor 122 may dynamically determine that a confidence threshold value in the form of a numerical ratio (e.g. 75% of the number instances of the common electronic document) may be required for determining whether a more densely populated electronic document has been read by a recipient user. Any other implementations or combinations of the above described implementations for setting the confidence threshold value are contemplated.

In response to determining that the number of delivery reports exceeds the confidence threshold value, at operation 530, the processor 122 may determine that the compliance result for the first client device is based on a sufficient user interaction sample size. That is, at operation 530, the processor 122 may determine that the recipient user at the first client device 102a has read the common electronic document 300 based on threshold metrics that align with several other recipient users. For example, if one of the threshold metrics for determining whether a user may have read a common electronic document 300 is an average scroll rate, where the scroll rate is based on the scroll rates received in the plurality of delivery reports, the processor 122 may determine that the compliance result based on the average scroll rate with reasonable confidence when the confidence threshold hold is met.

In some examples, the processor 122 may determine that the number of received delivery reports may not exceed a confidence threshold value. For instance, if the confidence threshold value is 75% of delivery reports that are expected to be received from client devices and if the processor 122 determines that only 50% of the expected delivery reports are received, the processor 122 may delay operation 430 (FIG. 4). That is, if the processor 122 determines that the number of received delivery reports has not yet exceeded the confidence threshold value, the processor 122 may wait for further delivery reports from other client devices. In some examples, the processor 122 may provide for display, at the document management server 110 or any other electronic device of the system 100 (FIG), an indication or a displayable message that compliance results are pending.

In some examples, if the processor 122 determines that the number of received delivery reports has not yet exceeded the confidence threshold value, the processor 122 may provide for display a combination of: (a) a compliance result for the first client device 102a; and (b) an indication that the compliance result may be based on a less than optimal engagement vector or threshold metric(s) or an indication that the compliance result may be subject to refinement or update.

In some examples, if the processor 122 determines that the number of received delivery reports has not yet exceeded the confidence threshold value, the processor may monitor, over time, the number of delivery reports received at the document management server 110. In some examples, the processor 122 may keep a delivery report count associated with each respective common electronic document 300 and increment the delivery report count when further delivery reports are received at the document management server 110.

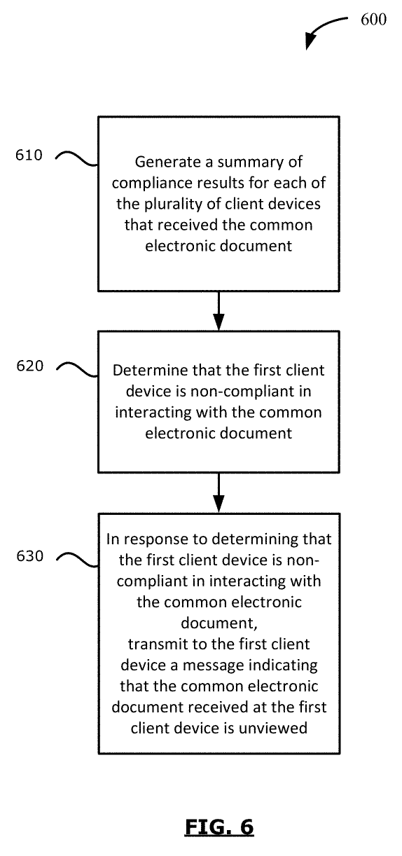

Reference is now made to FIG. 6, which illustrates a method 600 of monitoring a plurality of network-connected client devices, in accordance with an example of the present application. The method 600 may include operations that may be carried out by the document management server 110 (FIG. 1); however, client devices or a document originator device 140 (FIG. 1) may also perform some or all of the operations of the method 600. The method 600 may be implemented, at least in part, through processor-executable instructions stored for example at the document management application 128(a) (FIG. 1). In some examples, one or more of the operations may be implemented via processor-executable instructions of other applications 128 (FIG. 1) or of the operating system 126 (FIG. 1).

At operation 610, the processor 122 may generate for display a summary of compliance results for each of the plurality of client devices that received the common electronic document 300. In some examples, the processor 122 may generate a table for tracking each of the plurality of client devices that received the common electronic document 300 and a determined compliance result (e.g., operation 430, FIG. 4). The compliance status may include an indication of the extent that the recipient user has interacted with the common electronic document 300 based on interaction metrics, where the interaction metrics may be based on crowdsourced data relating to the extent that other recipient users interacted with the common electronic document 300. The compliance status may indicate that the common electronic document 300 has been determined to be read by the recipient user. In some examples, the processor 122 may generate date and time data for recording when recipient users associated with respective client devices were read.

At operation 620, the processor 122 may determine that the first client device 102a is non-compliant in interacting with the common electronic document 300. For example, the processor 122 may determine that the recipient user associated with the first client device 102a may have scrolled through the common electronic document 300 at a first scroll rate that is greater than the scroll rate threshold. When the first scroll rate may be greater than the scroll rate threshold, the processor 122 may determine that the recipient user likely could not have read the common electronic document 300. The common electronic document 300 may include dense content and may not be comprehended when the first scroll rate indicates that the rate of scrolling is relatively high.

In some examples, the processor 122 may determine that the first client device is non-compliant in interacting with the common electronic document 300 based on two or more threshold metrics defined in the engagement vector. The engagement vector may include a combination of a scroll rate threshold, a click-through threshold, or a pointer-activation threshold. For example, when determining whether the first client device 102a is compliant in interacting with the common electronic document 300, the processor 122 may require a combination of the first scroll rate being less than the scroll rate threshold, the click-through rate of the common electronic document being greater than the click-through threshold, or a pointing cursor having “hovered over” particular textual matter for at least a minimum duration of time.

In response to determining that the first client device is non-compliant in interacting with the common electronic document 300, at operation 630, the processor 122 may transmit, to the first client device 102a, a message indicating that the common electronic document 300 received at the first client device is unviewed. The message may be displayed on an output device of the first client device 102a.

In the examples described herein, a client device may be deemed compliant in interacting (e.g., reading or consuming) with the common electronic document 300 based on the engagement vector that is generated based on crowdsourced delivery report data. The crowdsourced delivery report data includes consumption data from other client devices interacting with that same common electronic document 300.

In some examples, even if a given client device may be deemed compliant for interacting with the common electronic document 300, in some examples, there can be variability in one or more threshold metrics included in the engagement vector for determining an extent of interaction with the common electronic document at a given client device. Thus, the document management server 110 may generate an engagement vector that includes an advanced client device category for client devices receiving user interaction from users having high familiarity with subject-matter of the common electronic document 300.

In an illustrative example, the common electronic document 300 may include matters relating to corporate finance (e.g., graphs, data tables, textual description, etc.). In this example, a lawyer specializing in corporate finance matters or an investment banker, for example, may be able to comprehend the common electronic document 300 more efficiently and easily than a recipient user who may not have an extensive background in corporate finance. Accordingly, a scroll rate threshold, a click-through threshold, or a threshold metric for hover-activated matter may be setup for multiple category of recipient users. It may be desirable to generate multiple engagement vectors for the common electronic document 300, where each engagement vector may be associated with a recipient user category. Thus, the processor 122 may conduct operations for generating an advanced engagement vector for use in association with client devices receiving user interaction from recipient users having high familiarity with subject matter of the common electronic document 300. The processor 122 may also conduct operations for generating a basic engagement vector for use in association with other client devices receiving user interaction from recipient users having low familiarity with the subject matter of the common electronic document 300 (e.g., a normal client device category). The processor 122 may determine which of the two or more engagement vectors to utilize based on a profile of the recipient user associated with the monitored client device.

Certain adaptations and modifications of the described embodiments can be made. Therefore, the above discussed embodiments are considered to be illustrative and not restrictive.

What is claimed is:

1. A processor-implemented method of monitoring, by a sender device, a plurality of network-connected client devices, the client devices receiving a common electronic document from the sender device, respective client devices displaying the common electronic document on an output device for facilitating user interaction with the common electronic document, the method comprising:
receiving, via a network connection to the network-connected client devices, a plurality of delivery reports from the client devices that received the common electronic document, the plurality of delivery reports including a first delivery report having first consumption data associated with the common electronic document at a first client device;
generating, by the sender device, an engagement vector from the plurality of delivery reports, the generated engagement vector including a threshold metric for determining an extent of interaction with the common electronic document at the respective client devices; and
providing, for display by the sender device, a compliance result for the first client device by comparing the threshold metric to the first consumption data of the first client device.

2. The method of claim 1, further comprising:
in response to receiving, via the network connection, further delivery reports from further client devices receiving the common electronic document, updating the engagement vector based on the received further delivery reports.

3. The method of claim 1, wherein the engagement vector is derived from statistical analysis of the received delivery reports.

4. The method of claim 1, wherein the threshold metric includes a scroll rate threshold metric for determining rate of user interaction of the common electronic document at the respective client devices.

5. The method of claim 4, further comprising:
determining, based on the first consumption data, that a first scroll rate of the common electronic document displayed at the first client device is less than the scroll rate threshold metric; and
in response to determining that the first scroll rate of the common electronic document displayed at the first client device is less than the scroll rate threshold metric, determining that the common electronic document is read at the first client device.

6. The method of claim 1, wherein the threshold metric includes a click-through threshold for determining extent of interaction with hyperlinks.

7. The method of claim 6, further comprising:
determining, based on the first consumption data, that a click-through rate of the common electronic document displayed at the first client device is greater than the click-through threshold; and
in response to determining that the click-through rate of the common electronic document displayed at the first client device is greater than the click-through threshold, determining that the common electronic document is read at the first client device.

8. The method of claim 1, wherein the common electronic document is divided into more than one document section, and wherein more than one document section is associated with a section threshold metric for determining the extent of interaction with that respective document section.

9. The method of claim 1, further comprising:
determining based on the compliance result that the first client device is non-compliant in interacting with the common electronic document; and
in response to determining that the first client device is non-compliant in interacting with the common electronic document, transmitting to the first client device a message indicating that the common electronic document received at the first client device is unviewed.

10. The method of claim 1, further comprising:
generating, by the sender device for display, a summary of compliance results for the plurality of client devices that received the common electronic document.

11. The method of claim 1, wherein the sender device is a document management server, and wherein the document management server receives, from a document originator device, the common electronic document for distribution to the plurality of network-connected client devices.

12. The method of claim 1, the method further comprising:
prior to providing a compliance result for the first client device, determining a number of delivery reports received at the sender device for that common electronic document;
determining that the number of delivery reports exceeds a confidence threshold value; and
in response to determining that the number of delivery reports exceeds the confidence threshold value, determine that the compliance result for the first client device is based on a threshold user interaction sample size.

13. The method of claim 1, wherein the engagement vector includes an advanced client device category for devices associated with user interaction from users having high familiarity with subject-matter of the common electronic document,
and wherein the generated engagement vector includes a normal client device category for devices associated with user interaction from users having low familiarity with subject matter of the common electronic document.

14. An electronic device monitoring a plurality of network-connected client devices, the electronic device comprising:
a processor;
a communication subsystem coupled to the processor for transmitting a common electronic document to the plurality of network-connected client devices, respective client devices displaying the common electronic document on an output device for facilitating recipient user interaction with the common electronic document on that client device; and
a memory coupled to the processor and storing processor-readable instructions that, when executed, cause the processor to:
receive, via the communication subsystem, a plurality of delivery reports from the respective client devices that received the common electronic document, the plurality of delivery reports including a first delivery report having first consumption data associated with the common electronic document at a first client device;
generate an engagement vector from the plurality of delivery reports, the engagement vector includes a threshold metric for determining an extent of interaction with the common electronic document at the respective client devices; and
provide, for display at the electronic device, a compliance result for the first client device by comparing the threshold metric to the first consumption data of the first client device.

15. The electronic device of claim 14, wherein the threshold metric includes a scroll rate threshold metric for determining rate of user interaction of the common electronic document at the respective client devices, and wherein the processor-readable instructions that, when executed, further cause the processor to:
determine, based on the first consumption data, that a first scroll rate of the common electronic document displayed at the first client device is less than the scroll rate threshold metric; and
in response to determining that the first scroll rate of the common electronic document displayed at the first client device is less than the first scroll rate threshold metric, determine that the common electronic document is read at the first client device.

16. The electronic device of claim 14, wherein the threshold metric includes a click-through threshold for determining extent of interaction with hyperlinks, and wherein the processor-readable instructions that, when executed, further cause the processor to:
determine, based on the first consumption data, that a click-through rate of the common electronic document displayed at the first client device is greater than the click-through threshold; and
in response to determining that the click-through rate of the common electronic document displayed at the first client device is greater than the click-through threshold, determine that the common electronic document is read at the first client device.

17. The electronic device of claim 14, wherein the common electronic document is divided into more than one document section, and wherein the more than one document section is associated with a section threshold metric for determining the extent of interaction with that respective document section.

18. The electronic device of claim 14, wherein the processor-readable instructions, when executed, further cause the processor to:
determine based on the compliance result that the first client device is non-compliant in interacting with the common electronic document; and
in response to determining that the first client device is non-compliant in interacting with the common electronic document, transmit to the first client device a message indicating that the common electronic document received at the first client device is unviewed.

19. The electronic device of claim 14, wherein the processor-readable instructions, when executed, further cause the processor to:
prior to determining the compliance result for the first client device, determine a number of delivery reports received at the electronic device for that common electronic document;
determine that the number of delivery reports exceeds a confidence threshold value; and
in response to determining that the number of delivery reports exceeds the confidence threshold value, determine that the compliance result for the first client device is based on a threshold user interaction sample size.

20. A non-transitory computer-readable storage medium comprising processor-readable instructions which, when executed, configure a processor to:
receive, via a network connection to network-connected client devices, a plurality of delivery reports from the client devices that received a common electronic document, the plurality of delivery reports including a first delivery report having first consumption data associated with the common electronic document at a first client device;
generate, by a sender device, an engagement vector for the plurality of delivery reports, the engagement vector including a threshold metric for determining an extent of interaction with the common electronic document at respective client devices; and
provide, for display by the sender device, a compliance result for the first client device by comparing the threshold metric to the first consumption data of the first client device.
